(19) United States
(12) Patent Application Publication
(10) Pub. No.: US 2009/0239638 A1
(43) Pub. Date: Sep. 24, 2009

(54) Gaming Machine Executing Feature Game Corresponding to Arrangement of Trigger Symbol Thereof

(75) Inventor: Fumiya ABE, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Gaming America, Inc., Las Vegas, NV (US)

(21) Appl. No.: 12/402,818

(22) Filed: Mar. 12, 2009

Related U.S. Application Data
(60) Provisional application No. 61/038,492, filed on Mar. 21, 2008.

(51) Int. Cl. A63F 13/00

(52) U.S. Cl. 463/20

(57) ABSTRACT

A gaming machine includes a basic game and a plurality of feature games that are executed in a case where a predetermined condition is satisfied in the basic game. A CPU determines whether at least a predetermined number of trigger symbols are included among symbols rearranged in a symbol display regions. In a case where at least the predetermined number of trigger symbols is displayed, the CPU executes a feature game corresponding to the number and the positions of the displayed trigger symbols.

### CROSS REFERENCE TO RELATED APPLICATIONS

This application claims benefit of U.S. Provisional Application No. 61/038,492, filed Mar. 21, 2008, the entire contents of which are incorporated herein by reference.

### BACKGROUND OF THE INVENTION

1. Field of the Invention

The present invention relates to a gaming machine including a plurality of feature games and executing a feature game in accordance with the arrangement of trigger symbols thereof.

2. Related Art

Conventionally, gaming machines executing feature games such as bonus games, that are different from basic games, in a case where predetermined symbols are statically displayed in a predetermined way, are known. A gaming machine disclosed in U.S. Pat. No. 7,278,919 includes a plurality of kinds of feature games, and, in a case where a predetermined condition is satisfied in a basic game, starts a bonus game that is randomly selected from the plurality of feature games after the condition is met. In this case, even when the predetermined condition is satisfied, a bonus game is randomly selected. For example, if a game that is difficult for the player is selected, the player will be discouraged right after being excited in the basic game, as they may think there is only a small chance to win a bonus. This may deter the player.

Therefore, an objective of the present invention is to provide a gaming machine including a plurality of feature games, where a feature game associated with the arrangement of trigger symbols is executed and an expectation for winning a bonus is maintained, thereby not discouraging the player from participating in the feature game, and a control method thereof.

### SUMMARY OF THE INVENTION

In a first aspect of the present invention, a gaming machine is provided including: a display for displaying a predetermined symbol from each of a plurality of symbol groups; memory for storing a plurality of display patterns for a trigger symbol, in which the trigger symbol is included in the plurality of symbol groups and triggers a transition to a second game by being displayed in any one of the display patterns; and a controller for executing steps of: (a) generating random numbers and starting a first game; (b) dynamically displaying each of the plurality of symbol groups; (c) determining a symbol to be statically displayed on the display, in accordance with the random numbers; (d) displaying each of the symbols determined in step (c) on the display; (e) determining whether the trigger symbol is displayed in any one of the display patterns; and (f) in a case where the trigger symbol is displayed in any one of the display patterns, executing the second game associated with the display pattern.

In a second aspect of the present invention, a gaming machine is provided including: a display for displaying a predetermined symbol from each of a plurality of symbol groups; memory for storing a plurality of specific positions in the display in which a trigger symbol that triggers a transition to a second game is displayed, and a plurality of second games associated therewith; and a controller for executing steps of: (a) generating random numbers and starting a first game; (b) dynamically displaying each of the plurality of symbol groups; (c) determining a symbol, in each of the plurality of symbol groups, to be statically displayed on the display in accordance with the random numbers; (d) displaying each of the symbols determined in step (c) on the display; (e) determining whether the trigger symbol is displayed in the specific position; and (f) in a case where the trigger symbol is displayed in the specific position, executing the second game corresponding to the specific position.

In a third aspect of the present invention, a gaming machine includes: a display for displaying a predetermined symbol from each of a plurality of symbol groups; memory for storing a plurality of combinations of specific positions on the display in which a trigger symbol is displayed and a number of trigger symbols displayed in the display, and a plurality of second games associated therewith; and a controller for executing steps of: (a) generating random numbers and starting a first game; (b) dynamically displaying each of the plurality of symbol groups; (c) determining a symbol, in each of the plurality of symbol groups, to be statically displayed on the display in accordance with the random numbers; (d) displaying each of the symbols determined in step (c) on the display; (e) determining whether a predetermined number of the trigger symbols are displayed in a predetermined combination included in the plurality of combinations; (f) in a case where the trigger symbol is displayed in the predetermined combination, executing the second game corresponding to the combination.

In a fourth aspect of the present invention, a gaming machine is provided including: a display for displaying a plurality of reels having a plurality of symbols; memory for storing a plurality of patterns on the display in which a predetermined number of trigger symbols triggering a transition to a second game are displayed, and a plurality of second games associated therewith; and a controller for executing steps of: (a) starting a first game; (b) determining symbols to be rearranged in the display for each of the plurality of reels; (c) rotating the plurality of reels and dynamically displaying the plurality of symbols; (d) statically displaying the symbols determined in step (b) on each of the plurality of reels; (e) determining whether a predetermined number of the trigger symbols are included among the symbols displayed statically; (f) in a case where it is determined in step (e) that the predetermined number of the trigger symbols are included, identifying a pattern in which the trigger symbols are displayed; and (g) in a case where the pattern in which the trigger symbols are displayed correspond to any one of the plurality of patterns stored in the memory, executing the second game, associated with the pattern, from the plurality of second games.

In a fifth aspect of the present invention, a gaming machine is provided including: a display for displaying a plurality of reels including a plurality of symbols; memory for storing a position of each of the plurality of reels when the predetermined symbol in the plurality of symbols is displayed on the display, and a plurality of second games associated therewith; and a controller for executing steps of: (a) starting a first game; (b) determining a stopping position of each of the plurality of reels; (c) rotating the plurality of reels and dynamically displaying the plurality of symbols; (d) stopping each of the plurality of reels at the stopping position determined in step (b); and (e) in a case in which the stopping positions determined in step (b) correspond to any one of the positions stored in the memory, executing the second game associated with the position.

According to a sixth aspect of the present invention, in the gaming machine described in the fifth aspect, the plurality of symbols are arranged on an outer circumferential surface of each of the plurality of reels; in step (c), the plurality of symbols are dynamically displayed by the plurality of reels rotating in a direction orthogonal to a predetermined rotation axis thereof; and the controller further executes steps of: (d2) identifying the stopping position of the plurality of reels after step (d); (d3) after step (d2), determining whether the reels are stopped so as to display the specific symbol; and executing step (e) on the basis of the result of step (d2).

### BRIEF DESCRIPTION OF THE DRAWINGS

FIG. 1 is a flow chart showing the flow of a game executed in a gaming machine according to an embodiment of the present invention;

FIG. 2 is a perspective view showing the appearance of the gaming machine according to the embodiment;

FIG. 3 is an enlarged front view showing a display area of the gaming machine according to the embodiment;

FIG. 4 is a block diagram of a controller of the gaming machine according to the embodiment;

FIG. 5 is a block diagram of a display/input controller of the gaming machine according to the embodiment;

FIG. 6 is a flow chart showing basic game processing executed in the gaming machine according to the embodiment;

FIG. 7 is the flow chart of game determination processing executed in the gaming machine according to the embodiment;

FIG. 8 is a diagram showings a feature/award flag determination table according to the embodiment of the present invention;

FIG. 9 is a diagram showing a trigger symbol rearrangement pattern/feature game association table according to the embodiment;

FIG. 10 is a display example of symbols including trigger symbols being rearranged, in the gaming machine according to the embodiment;

FIG. 11 is a display example of symbols including trigger symbols being rearranged, in the gaming machine according to the embodiment;

FIG. 12 is a perspective view showing the appearance of the gaming machine according to a second embodiment of the present invention;

FIG. 13 is a block diagram of a controller of the gaming machine according to the second embodiment; and

FIG. 14 is a flowchart for basic game processing executed by the gaming machine according to the second embodiment.

### DETAILED DESCRIPTION OF THE INVENTION

### First Embodiment

A first embodiment of the present invention is hereinafter described with reference to the accompanying drawings.

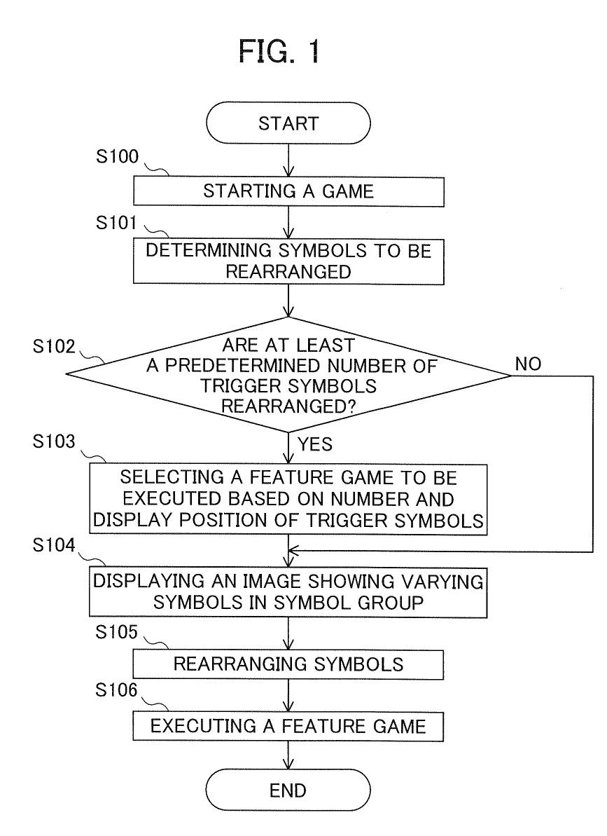

As shown in FIG. 1, a CPU 106 starts a basic game as a first game (Step S100), and determines symbols to be rearranged (Step S101). Details are described later. Subsequently, the CPU 106 determines whether at least a predetermined number of trigger symbols are included among the symbols determined to be rearranged (Step S102), and, in a case where at least a predetermined number of trigger symbols are included therein, the CPU 106 selects a feature game as a second game, which is executed in accordance with the number and arrangement of the trigger symbols to be rearranged (Step S103). In the case where the predetermined number of trigger symbols are not included therein in Step S102, the CPU advances to Step S104. In Step S104, the CPU 106 dynamically displays the symbols in the symbol groups and rearranges the symbols (Step S105). Furthermore, the CPU 106 executes the feature game selected in Step 103.

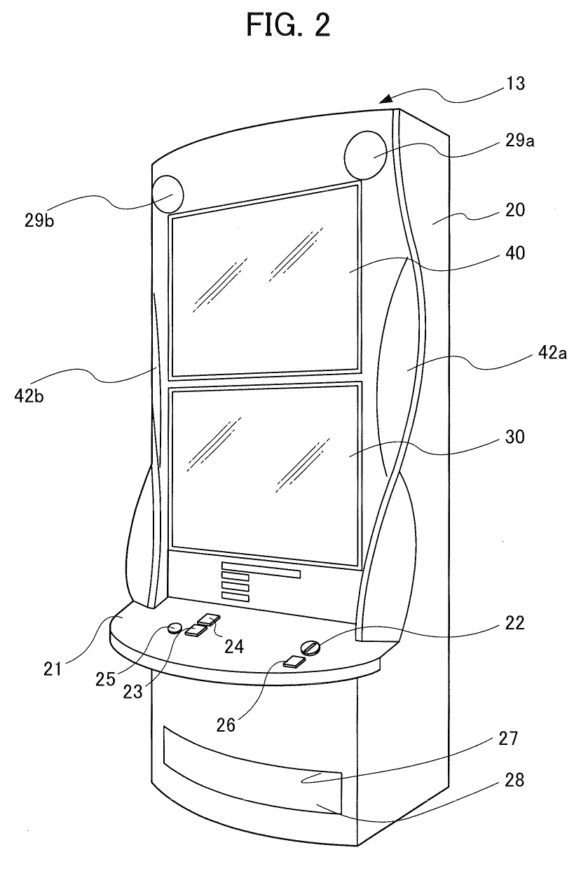

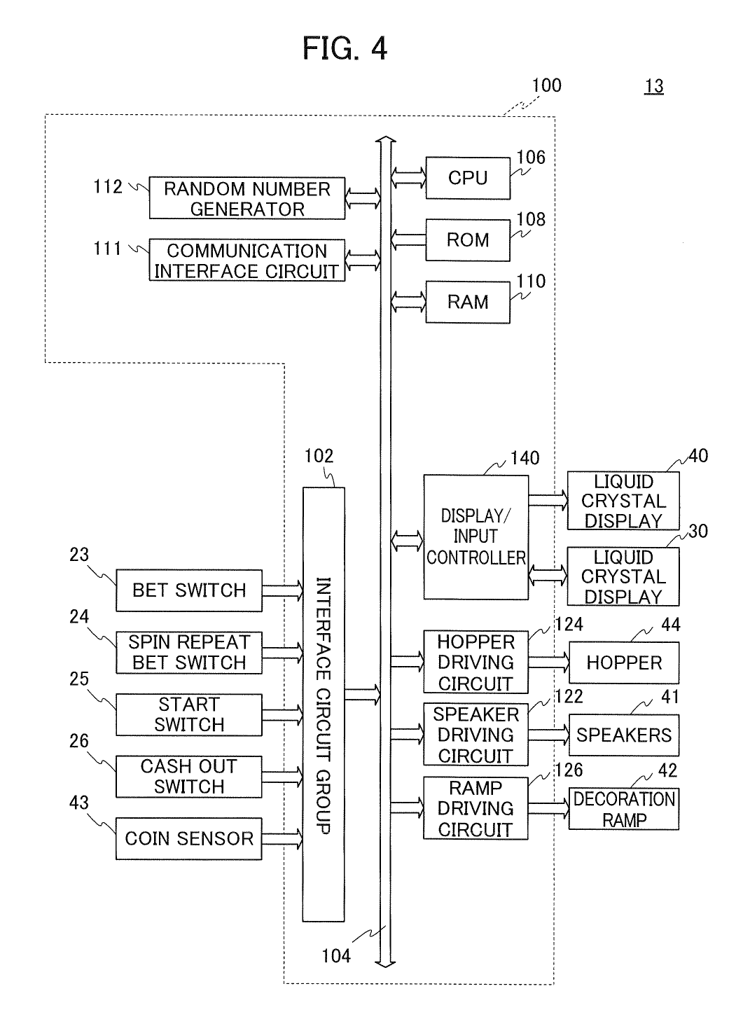

FIG. 2 is a perspective view showing the gaming machine 13 according to an embodiment of the present invention. The gaming machine 13 includes a cabinet 20. The cabinet 20 has a surface opening toward a player. The cabinet 20 contains various components including a game controller 100 (refer to FIG. 4) for electrically controlling the gaming machine 13, and a hopper 44 (refer to FIG. 4) for controlling the insertion, storage, and payout of coins as a game medium, and the like. The game medium is not limited to coins, and it can be, for example, medals, tokens, electronic money, or electronic valuable information (credits) equivalent thereto.

A liquid crystal display 30 is disposed at substantially the center of the front face of the cabinet 20, and a liquid crystal display 40 is disposed above the display 30.

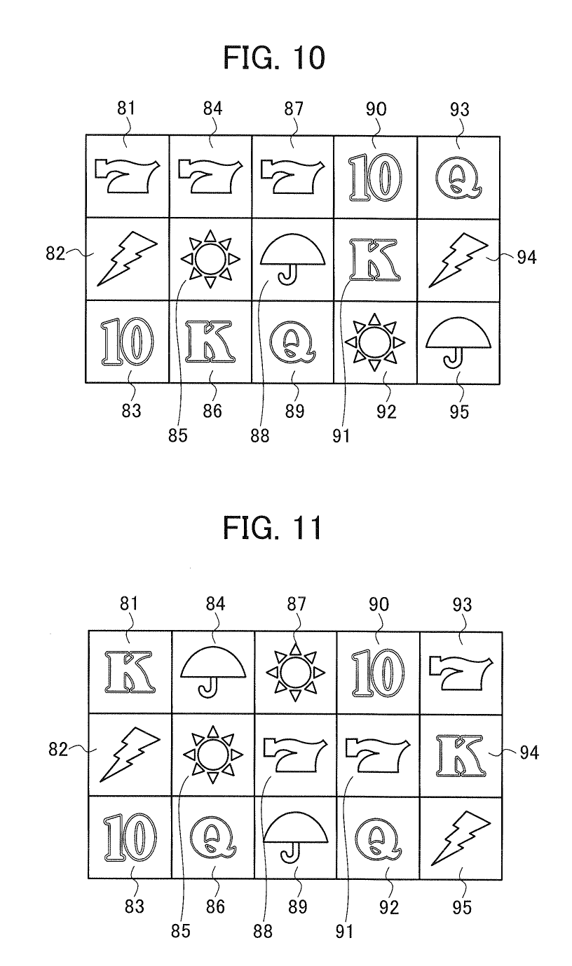

The liquid crystal display 30 is provided as a display device for displaying various kinds of images relating to the game such as rendered images. The player advances the game while observing the variety of images displayed on the liquid crystal display 30. In such a game, the liquid crystal display 30 displays a slot game as shown in FIGS. 10 and 11.

The liquid crystal display 30 of the gaming machine 13 mainly displays 15 symbols. Each of symbol display regions 81 to 95 displays a symbol from a plurality of symbols assigned to the symbol display regions 81 to 95. In the present embodiment, a unit game starts from an initial state where symbols are statically displayed in the symbol display regions 81 to 95, continually changes the displayed symbols, and then rearranges a symbol in each of the symbol display regions 81 to 95. In other words, the symbol display regions 81 to 95 are so-called video reels. Furthermore, the symbol display regions 81 to 95 are constituted of 15 video reels. It should be noted that the term “video reel” as used here represents a mechanism for displaying a reel on the liquid crystal display 30 in the form of an image, instead of a mechanical reel.

The other liquid crystal display 40 disposed above the liquid crystal display 30 is a sub display for displaying the rules of the game, demonstration movies, and the like.

Sound transmission openings 29a and 29b are provided on both the left and right sides above the liquid crystal display 40, which allow the sound effects generated by a speaker 41 (see FIG. 4) stored within the cabinet 20 to propagate outside the cabinet 20. The sound effects are generated from the sound transmission openings 29a and 29b according to the advance of the game. In addition, decorative lamps 42a and 42b are provided on both the left and right sides, substantially in the middle of the gaming machine 13. The decorative lamps 42a and 42b emit light in accordance with the progress of the game.

A substantially horizontal operation unit 21 is disposed below the liquid crystal display 30. Furthermore, a coin slot 22, which allows the player to insert coins, is provided on the right side of the operation unit 21. On the other hand, the components provided to the left side of the operation unit 21 include: a BET switch 23 allowing the player to select the number of coins as a gaming medium to be bet; and a spin repeat bet switch 24 allowing the player to play the game again without changing the number of coins bet in the previous game. Such an arrangement allows the player to set the number of coins bet, by pushing either the BET switch 23 or the spin repeat bet switch 24.

In the operation unit 21, a start switch 25 for accepting a starting operation of each game by a player is disposed on the left side of the bet switch 23. By a pushing operation on either the start switch 25 or the spin repeat bet switch 24, which serves as a trigger to start the game, the liquid crystal display 30 displays an image of the aforementioned 15 video reels, which then start to rotate.

On the other hand, a cash out switch 26 is provided near the coin slot 22 on the aforementioned operation unit 21. When the player presses the cash out switch 26, the inserted coins are discharged from a coin discharge slot 27 opening into a lower part of the front face of the cabinet 20. The discharged coins can be gathered on a coin tray 28.

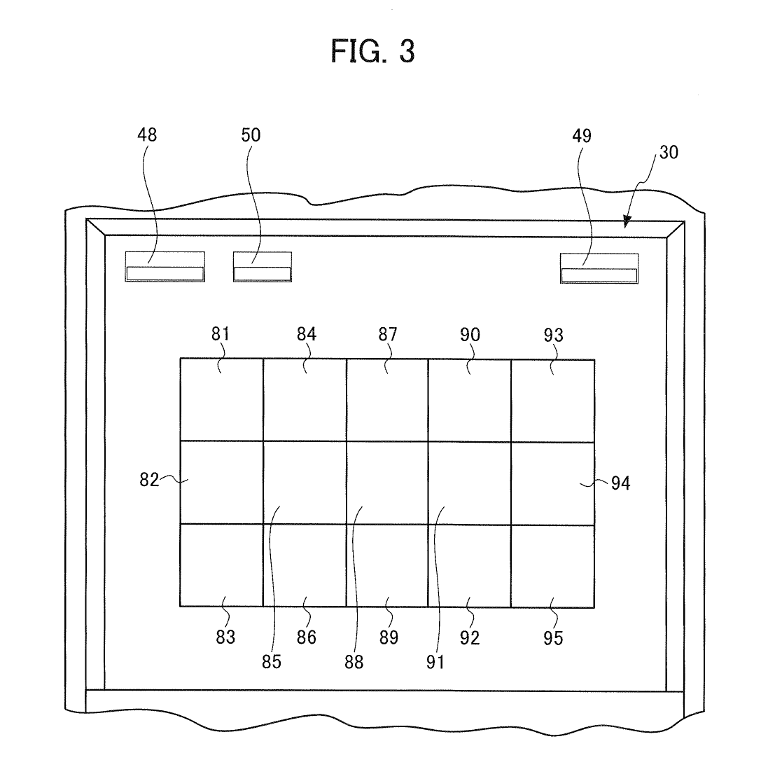

FIG. 3 is an enlarged view showing the display region of the gaming machine 13. The gaming machine 13 includes the symbol display regions 81 to 95 arranged in a 3×5 matrix, as shown in FIG. 3. The symbol display regions are also referred to as symbol display blocks or symbol display positions. The abovementioned 15 video reels correspond to the symbol display regions 81 to 95.

The game available in the present embodiment is a game in which an award is provided in accordance with the number of symbols of the same kind displayed in the symbol display regions 81 to 95. The number of symbols of the same kind, which qualify for an award, can be arbitrarily defined, for example, as at least 3.

Furthermore, the liquid crystal display 30 displays, on the upper portion of the symbol display regions 81 to 95, starting from the left, a payout display portion 48, a bet amount display portion 50, and a credit amount display portion 49. The payout display portion 48 displays the number of coins to be paid out, in a case where at least a predetermined number of symbols of the same kind are rearranged in the symbol display regions 81 to 95, thus qualifying for an award. The credit amount display portion 49 displays the credit amount of coins stored in the gaming machine 13. The bet amount display portion 50 displays the bet amount, i.e. the number of coins bet.

FIG. 4 is a block diagram showing the electrical configuration of the game controller 100 of the gaming machine 13. As shown in FIG. 4, the game controller 100 of the gaming machine 13 is a micro computer, and includes an interface circuit group 102, an input/output bus 104, a CPU 106, ROM 108, RAM 110, a communication interface circuit 111, a random number generator 112, a speaker driving circuit 122, a hopper driving circuit 124, a lamp driving circuit 126, and a display/input controller 140.

The interface circuit group 102 is connected to the input/output bus 104. The input/output bus 104 performs input/output of data signals or address signals to and from the CPU 106.

The start switch 25 is connected to the interface circuit group 102. A start signal output from the start switch 25 is converted to a predetermined signal by the interface circuit group 102 and is then supplied to the input/output bus 104.

The BET switch 23, the spin repeat bet switch 24, and the cash out switch 26 are also connected to the interface circuit group 102. Switching signals output from the switches are also supplied to the interface circuit group 102 and converted to predetermined signals, and then supplied to the input-output bus 104 by the interface circuit group 102.

A coin sensor 43 is also connected to the interface circuit group 102. The coin sensor 43 is a sensor for detecting coins inserted into the coin slot 22. The coin sensor 43 is provided in combination with the coin slot 22. A sensing signal outputted from the coin sensor 43 is also supplied to the interface circuit group 102 and converted into a predetermined signal by the interface circuit group 102, and then supplied to the input/output bus 104.

The ROM 108 and the RAM 110 are connected to the input/output bus 104.

Upon acceptance of the start operation of a game from the start switch 25, the CPU 106 reads and executes a game program. The game program has been programmed so as to instruct the CPU 106 to perform the following operation. That is to say, according to the game program, the CPU 106 displays, via the display/input controller 140, an image of changing symbols on each of the symbol display regions of the liquid crystal display 30. Then, the CPU 106 statically displays an image of the symbol display regions 81 to 95 such that the combination of the symbols on the symbol display regions 81 to 95 (15 video reels) are rearranged. In a case where at least a predetermined number of symbols of the same kind are included among the symbols statically displayed, the CPU 106 pays out a predetermined amount of coins corresponding to the kind of symbol.

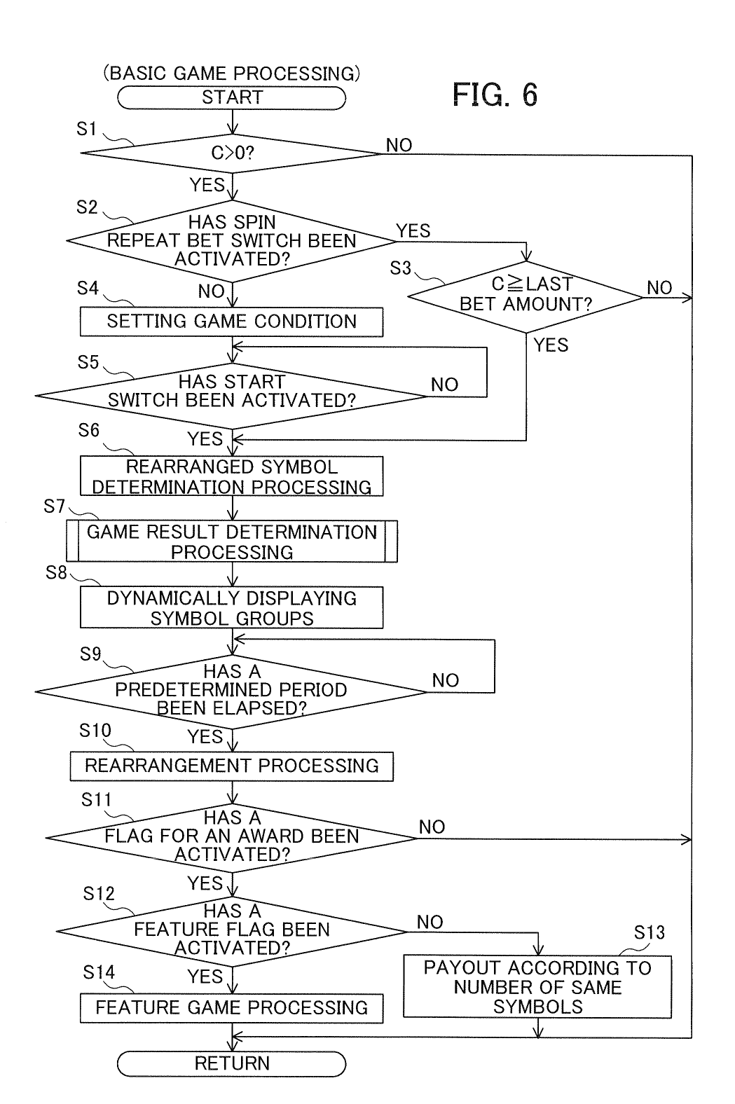

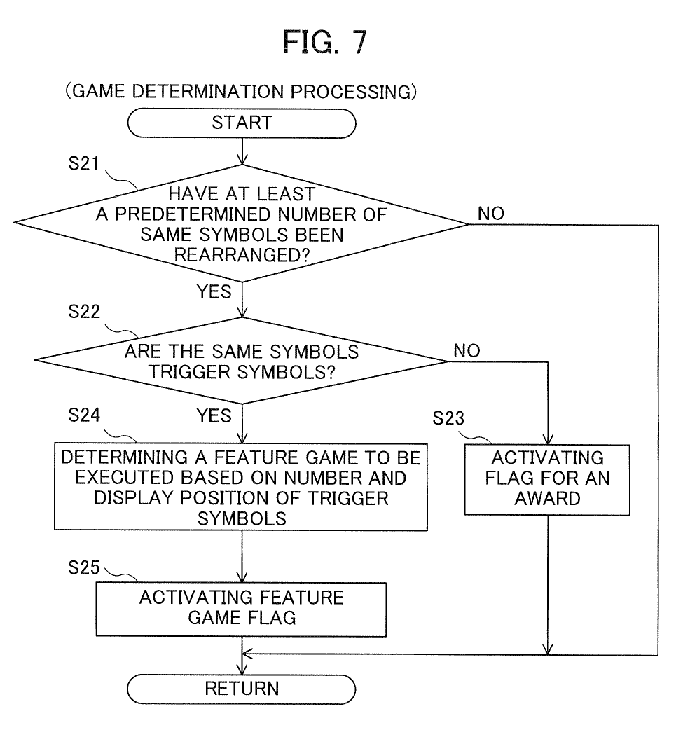

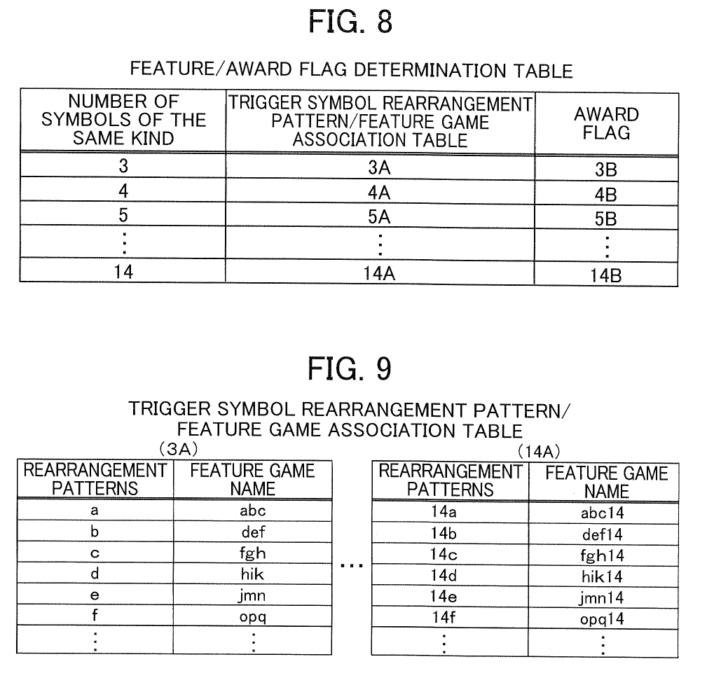

The ROM 108 stores a control program for governing and controlling the gaming machine 13, a program for executing routines as shown in FIGS. 6 and 7 (hereinafter referred to as a “routine execution program”), and initial data for executing the control program, and various data tables used in determination processing. The routine execution program includes the abovementioned basic game program. Examples of the data tables include tables such as those shown in FIGS. 8 and 9. The RAM 110 temporarily stores the values of flags and variables, and the like used in the control program.

The game program contains a symbol rearrangement determination program. The symbol rearrangement determination program determines 15 symbols to be rearranged on the symbol display regions 81 to 95. The symbol rearrangement determination program includes symbol weighted data corresponding to a plurality of payout ratios (for example, 80%, 84%, and 88%). The symbol weighted data represents correspondence relation between each symbol and one or a plurality of random number values included in a predetermined range (0 to 65535), for each of the 15 video reels. The payout ratio is determined on the basis of payout ratio setting data stored in the ROM 108. The symbol to be rearranged is determined on the basis of the symbol weighted data corresponding to the payout ratio.

A communication interface circuit 111 is also connected to the input/output bus 104. The communication interface circuit 111 is a circuit for communication with a center controller and the like over a network including a various LANs.

A random number generator 112 for generating random numbers is also connected to the input/output bus 104. The random number generator 112 generates random numbers included in a certain range of numerical values, for example, 0 to 65535 (2¹⁶−1). Alternatively, the random numbers may be generated by arithmetic processing of the CPU 106.

A speaker driving circuit 122 for driving the speaker 41 is also connected to the input/output bus 104. The CPU 106 reads sound data stored in the ROM 108, and transmits the sound data to the speaker driving circuit 122 via the input/output bus 104. This enables the speaker 41 to emit predetermined sound effects.

A hopper driving circuit 124 for driving the hopper 44 is also connected to the input/output bus 104. Upon receipt of a cash out signal input from the cash out switch 26, the CPU 106 transmits a driving signal to the hopper driving circuit 124 via the input/output bus 104. This enables the hopper 44 to pay out a number of coins corresponding to the remainder of credits at that point, which is stored in a predetermined memory area of the RAM 110.

Alternatively, the payout of the coins may be performed in a mode of storing credit data in a data card or the like, instead of using physical coins. That is to say, with such an arrangement, the player may have his/her own card, which serves as a storage medium. Upon the player inserting this card into the gaming machine 13, the data relating to the credit is stored in the card. Alternatively, bar coded tickets can be printed out. The payout method or exchange method applied in the game hall can be used.

A lamp driving circuit 126 is also connected to the input/output bus 104 for driving the decorative lamps 42a and 42b. The CPU 106 sends signals for driving the lamps under a predetermined condition based on the program stored in the ROM 108, to the lamp driving circuit 126. This makes the decorative lamps 42a and 42b to blink.

The display/input controller 140 is also connected to the input/output bus 104. The CPU 106 generates an image display instruction according to the state of the game and the result of the game, and outputs the generated image display instruction to the display/input controller 140 via the input/output bus 104. Upon receipt of the image display instruction input from the CPU 106, the display/input controller 140 generates a driving signal for driving the liquid crystal display 30 and the liquid crystal display 40 according to the image display instruction, and outputs the driving signal thus generated to the liquid crystal display 30 and liquid crystal display 40. As a result, a predetermined image is displayed on the liquid crystal display 30 and the liquid crystal display 40. The display/input controller 140 also sends, as an input signal, the signal accepted by a touch panel 32 on the liquid crystal display 30, via the input-output bus 104 to the CPU 106. The image display instruction also contains the instructions in accordance with the payout number display portion 48, the credit number display portion 49, and the bet number display portion 50.

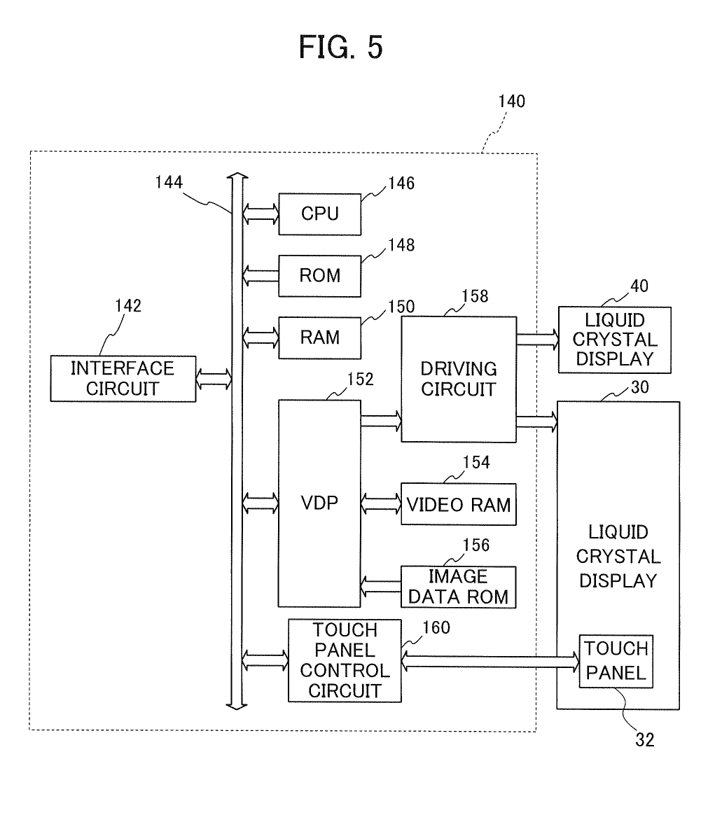

FIG. 5 is a block diagram showing the electrical configuration of the display/input controller 140 of the gaming machine 13. The display/input controller 140 of the gaming machine 13 is a sub-microcomputer for performing image display processing and input control for the touch panel 32. The display/input controller 140 includes an interface circuit 142, an input/output bus 144, a CPU 146, ROM 148, RAM 150, a VDP 152, video RAM 154, image data ROM 156, a driving circuit 158, and a touch panel control circuit 160.

The interface circuit 142 is connected to the input-output bus 144. An image display command output from the CPU 106 of the aforementioned game controller 100 is supplied to the input/output bus 144 via the interface circuit 142. The input/output bus 144 performs input/output of data signals or address signals to/from the CPU 146.

ROM 148 and RAM 150 are connected to the input/output bus 144. The ROM 148 stores a display control program for generating a driving signal, which is to be supplied to the liquid crystal display 30 and the liquid crystal display 40, according to an image display command received from the CPU 106 of the aforementioned game controller 100. On the other hand, the RAM 150 stores flags and values of variables used in the display control program.

The VDP 152 is also connected to the input/output bus 144. The VDP 152 is a processing device including a so-called sprite circuit, a screen circuit, a palette circuit and the like, and is capable of performing various processing for displaying an image on the liquid crystal display 30 and the liquid crystal display 40. The video RAM 154 and the image data ROM 156 are connected to the VDP 152. The video RAM 154 stores image data based on the image display instructions from the CPU 106 on the game controller 100. The image data ROM 156 stores various kinds of image data containing the abovementioned effect image data. Furthermore, the driving circuit 158 for outputting a driving signal for driving the liquid crystal display 30 and the liquid crystal display 40 is connected to the VDP 152.

By reading and executing the display control program stored in the ROM 148, the CPU 146 instructs the video RAM 154 to store image data to be displayed on the liquid crystal display 30 and the liquid crystal display 40 in response to the image display instructions from the CPU 106 on the game controller 100. The image display instruction includes various types of image display instructions, such as the abovementioned display instruction of rendered image.

The image data ROM 156 stores various kinds of image data including the rendered image data.

The touch panel control circuit 160 sends, as an input signal, the signal inputted through the touch panel 32 on the liquid crystal display 30, via the input-output bus 144 to the CPU 106.

FIG. 6 is a flow chart showing the flow of processing in the basic game of the gaming machine 13 to be executed by the game controller 100 of the gaming machine 13. The one routine shown in FIG. 6 corresponds to one unit of the game.

In addition, it is supposed that the gaming machine 13 is activated in advance and the variables used in the CPU 106 on the game controller 100 are initialized to predetermined values, respectively, thereby providing a stationary action of the gaming machine 13.

Firstly, the CPU 106 on the game controller 100 determines whether certain credits as the number of remaining coins inserted by the player remain (Step S1). More specifically, the CPU 106 reads a credit number C stored in the RAM 110, and performs processing based on the read credit number C. When the credit number C is “0” (when the result is NO in Step S1), the CPU 106 cannot start any game and, therefore, terminates the present routine without performing any processing. On the other hand, when the credit number C is at least “1” (when the result is YES in Step S1), the CPU 106 determines that the credits remain, and moves on to Step S2.

In Step S2, the CPU 106 determines whether the spin repeat bet switch 24 has been pressed. In a case where the spin repeat bet switch 24 has been pressed, and accordingly, in a case of reception of an operation signal via the spin repeat bet switch 24 (in the case of a YES determination in Step S2), the CPU 106 advances to Step S3. On the other hand, in a case where no operation signal is input via the spin repeat switch 24 for a predetermined period of time (in a case of a NO determination in Step S2), the CPU 106 determines that the spin repeat bet switch 24 has not been pushed, and accordingly, advances to Step S4.

On the other hand, in Step S3, the CPU 106 determines whether or not the credit amount C is at least the bet amount in the previous game. In other words, the CPU 106 determines whether or not the player can start the game by pressing the spin repeat bet switch 24. More specifically, when the spin repeat bet switch 24 is pressed and an operation signal is then inputted from the spin repeat bet switch 24, the CPU 106 reads the credit number C written in a predetermined memory area of the RAM 110 and the bet amount in the previous game, and then performs processing based on the relationship between the read credit number C and the read bet amount, namely whether the value of the credit number C is not less than the bet amount in the previous game. In a case where the aforementioned credit amount C is determined to be less than the bet amount in the previous game (in a case of a NO determination in Step S3), the CPU 106 cannot start the game, and accordingly terminates this routine without performing any processing. On the other hand, in a case where determination has been made that the aforementioned credit amount C is at least the bet amount in the previous game (in a case of a YES determination in Step S3), the CPU 106 subtracts the bet amount in the previous game from the aforementioned credit amount C, and stores the subtracted value in a predetermined area of the RAM 110. The CPU 106 then advances to Step S6.

On the other hand, in Step S4, the CPU 106 sets the game conditions. More specifically, the CPU 106 determines the number of coins to be bet in the unit game, depending on the operation of the BET switch 23. At this time, the CPU 106 receives operation signals sent in accordance with the operation of the BET switch 23 and, based on the number of the received operation signals, causes the bet amount to be stored in a predetermined memory area of the RAM 110. The CPU 106 reads out the credit amount C written in a predetermined memory region in the RAM 110. Then, the CPU 106 subtracts the bet amount from the credit amount C thus read out, and stores the value thus subtracted in a predetermined memory region in the RAM 110. The CPU 106 then advances to Step S5.

In Step S5, the CPU 106 determines whether the start switch 25 has been activated or not, and thus stands by until the player operates the start switch 25. In a case where the start switch 25 is operated and an operation signal is received via the start switch 25 (in the case of a YES determination in Step S5), the CPU 106 determines that the start switch 25 has been operated, and advances to Step S6.

In Step S6, the CPU 106 performs rearranged symbol determination processing. The CPU 106 first acquires 5 random numbers in the range of 0 to 65535, generated by a random number generator 112, which correspond to the 15 video reels. The CPU 106 then reads the payout ratio setting data from the ROM 108 and stores the data in the RAM 110, references the symbol weighing data corresponding thereto, and determines the symbols to be rearranged in the symbol display regions 81 to 95, in other words for each of the 15 video reels, based upon 15 random numbers. The CPU 106 then advances to Step S7.

In Step S7, the CPU 106 performs game result determination processing. In the game result determination processing, the CPU 106 determines whether a winning condition is satisfied or not, on the basis of the symbols to be rearranged, determined in Step S6. This processing is described later with reference to FIG. 7. After this processing, the CPU 106 advances to Step S8.

In Step S8, the CPU 106 displays an image where the symbols shown in the symbol display regions 81 to 95 are changing. For example, an image where the 15 video reels are rotating or where the symbols are changing in other ways is displayed.

After displaying an image where the symbols shown in the symbol display regions 81 to 95 are changing, the CPU 106 stands by for a predetermined amount of time (Step S9). After the predetermined amount of time has elapsed (in the case of a YES determination in Step S9), the CPU 106 stops displaying the images where the symbols shown in the symbol display regions 81 to 95 are changing, thus rearranging the symbols in the symbol display regions 81 to 95 (Step S10). Subsequently, the CPU 106 advances to Step S11.

In Step S11, the CPU 106 determines whether a flag indicating an award is activated or not, which is stored in the predetermined memory area of the RAM 110. In a case where the flag indicating an award is not activated (in the case of a NO determination in Step S11), the CPU 106 terminates this routine. On the other hand, in a case where the flag is activated (in the case of a YES determination in Step S11), the CPU 106 advances to Step S12.

In Step S12, the CPU 106 determines whether a flag indicating a transition to a feature game stored in the predetermined memory region of the RAM 110 (hereinafter referred to as “feature flag”) is activated or not as a result of the rearranged symbol determination processing of Step S6. More specifically, in a case where the flag indicating a transition to the bonus game is activated (in the case of a YES determination in Step S12), the CPU 106 advances to Step S14. On the other hand, in a case where the flag is not activated (in the case of a NO determination in Step S12), the CPU 106 advances to Step S13.

In Step S13, the CPU 106 pays out a number of coins corresponding to the number of symbols of the same kind being rearranged, which are at least a predetermined number. More specifically, the CPU 106 refers to a payout table (not shown), and calculates a payout number of coins corresponding to the number of symbols of the same kind being rearranged, which are at least a predetermined number. The CPU 106 reads the credit amount stored in the predetermined memory region of the RAM 110. Then, the CPU 106 calculates the sum total of the payout amount thus calculated (re-calculated) and the credit amount thus read out, and stores the value thus calculated in a predetermined memory area of the RAM 110. The CPU 106 displays the aforementioned value thus stored on the credit amount display portion 49. The CPU 106 then terminates the present routine.

In Step S14, the CPU 106 performs feature game processing. More specifically, the CPU 106 executes a feature game. The CPU 106 then terminates the present routine.

Game result determination processing is hereinafter described with reference to FIG. 7.

In Step S21 of FIG. 7, the CPU 106 determines whether at least a predetermined number of symbols of the same kind are rearranged or not. More specifically, the CPU 106 determines whether at least a predetermined number of symbols of the same kind are included among the symbols rearranged in the symbol display regions 81 to 95. The predetermined number is a smallest number of symbols of the same kind qualifying for an award. In the present embodiment, the predetermined number is 3; however, the number can be defined depending on the type of the game. In the case of a YES determination, the CPU 106 advances to Step S22. In the case of a NO determination, the CPU 106 advances to Step S8 of FIG. 6.

In Step S22, the CPU 106 determines whether the symbols of the same kind are the trigger symbols or not. The trigger symbol triggers an execution of a feature game as a second game, in a case where at least a predetermined number thereof are rearranged in the symbol display regions 81 to 95. In the case of a YES determination, the CPU 106 advances to Step S24. In the case of a NO determination, the CPU 106 advances to Step S23.

In Step S23, the CPU 106 activates a flag for an award for providing the award in a case where at least a predetermined number of symbols of the same kind are rearranged. More specifically, the CPU 106 references a feature/award flag determination table (described later with reference to FIG. 8) and activates a flag for providing an award in accordance with the number of symbols of the same kind. The CPU 106 then stores the activated flag in a predetermined region in the RAM 110. Afterwards, the CPU 106 advances to Step S8 of FIG. 6.

In Step S24, the CPU 106 determines a feature game to be executed, in accordance with the number and the position of the trigger symbols. More specifically, the CPU 106 first references a feature/award flag determination table, and determines the number of a trigger symbol rearrangement pattern/feature game association table to be referenced, in accordance with the number of symbols displayed. Subsequently, the CPU 106 references the trigger symbol rearrangement pattern/feature game association table (FIG. 9) having the determined number. In this table, the CPU 106 refers to the arrangement pattern of the trigger symbols rearranged in the symbol display regions 81 to 95, and selects a feature game associated with the arrangement pattern as a feature game to be executed in Step S14 of FIG. 6. A feature game is thus selected from a plurality of feature games, in accordance with the number and the position of the trigger symbols displayed.

In Step S25, the CPU 106 activates the feature game flag corresponding to the feature game to be executed. More specifically, the CPU 106 activates the feature game flag corresponding to the feature game selected in Step S24, and stores the flag in a predetermined storage region in the RAM 110. The CPU 106 then advances to Step S8 of FIG. 6.

The feature/award flag determination table is hereinafter described with reference to FIG. 8. The feature/award flag determination table is referenced in Step S23 or Step S25 of FIG. 7. In the feature/award flag determination table, the number of symbols of the same kind, a trigger symbol rearrangement pattern/feature game association table, and an award flags are associated with each other. A column “NUMBER OF SYMBOLS OF THE SAME KIND” stores data regarding the number of symbols of the same kind included among the symbols displayed after the rearrangement. A column “TRIGGER SYMBOL REARRANGEMENT PATTERN/FEATURE GAME ASSOCIATION TABLE” stores data regarding the number of the trigger symbol rearrangement pattern/feature game association table to be referenced. The trigger symbol rearrangement pattern/feature game association table is described later with reference to FIG. 9. A column “AWARD FLAG” stores data regarding the types of flags indicating an award. In the present embodiment, flag names are stored therein.

The feature/award flag determination table is referenced in Step S23 of FIG. 7 in a case where at least a predetermined number of symbols, which are not trigger symbols, are displayed. In this case, a different kind of flag for an award is activated. In other words, the CPU 106 first acquires number data regarding the number of symbols of the same kind being displayed, by referencing the column “NUMBER OF SYMBOLS OF THE SAME KIND”. Subsequently, the CPU 106 acquires data regarding the kind of flag stored in a field corresponding to the number data (in the present embodiment, stored in the same row), by referencing the column “AWARD FLAG”.

The feature/award flag determination table is referenced in Step S25 of FIG. 7 in a case where at least a predetermined number of trigger symbols are displayed. In this case, a feature game executed in Step S14 (FIG. 6) is determined on the basis of the number and the rearrangement pattern of trigger symbols. For this reason, the CPU 106 selects a trigger symbol rearrangement pattern/feature game association table to be referred to based on the number of trigger symbols displayed, and determines a feature game to be executed based on the rearrangement pattern, by referencing the trigger symbol rearrangement pattern/feature game association table (FIG. 9).

The CPU 106 first acquires number data regarding the number of trigger symbols displayed, by referencing the column “NUMBER OF SYMBOLS OF THE SAME KIND” in the feature/award flag determination table. Subsequently, the CPU 106 acquires table number data stored in a field corresponding to the number data (in the present embodiment, stored in the same row), by referencing the column “TRIGGER SYMBOL REARRANGEMENT PATTERN/FEATURE GAME ASSOCIATION TABLE”.

The trigger symbol rearrangement pattern/feature game association table is hereinafter described with reference to FIG. 9. The trigger symbol rearrangement pattern/feature game association table is referenced in Step S25 of FIG. 7. In other words, the table is referenced only in a case where at least the predetermined number of trigger symbols are displayed.

A plurality of the trigger symbol rearrangement pattern/feature game association tables are provided for each number of trigger symbols. For example, a trigger symbol rearrangement pattern/feature game association table 3A is a table referenced in a case in which 3 trigger symbols are displayed in the symbol display regions 81 to 95. All the tables are similarly configured, and rearrangement patterns and feature game names are associated with each other therein. As a representative example, the table 3A is hereinafter described.

In a column “REARRANGEMENT PATTERNS”, data regarding positions in the 15 symbol display regions 81 to 95, in which the three trigger symbols are displayed, is stored. A plurality of the rearrangement patterns are stored therein, each of which has different patterns of positions in which the trigger symbols are rearranged.

In a column “FEATURE GAME NAMES”, data regarding the names of feature games to be executed is stored. A plurality of the feature games are provided, each of which has different game contents. An arbitral number of the feature games can be provided. In addition, the rearrangement patterns and the feature game names are associated with each other. By acquiring one of the rearrangement patterns, the feature game name stored in the same row in the table is selected. Different feature games can thus be executed based on the rearrangement of the trigger symbols, even in cases where the same number of the trigger symbols are displayed.

Display examples of the symbol display regions 81 to 95 displayed on the liquid crystal display 30 are described with reference to FIGS. 10 and 11.

FIG. 10 shows the symbol display regions 81, 84 and 87 displaying the trigger symbols. It should be noted that, in the present embodiment, the trigger symbol is a “7” symbol. Thus, the CPU 106 first determines whether at least a predetermined number of symbols of the same kind are displayed or not (Step S21 of FIG. 7), and then, in a case where the symbols of the same kind are the trigger symbols (Step S22 of FIG. 7), determines a trigger symbol rearrangement pattern/feature game association table to be referenced, based upon the number of the symbols of the same kind and a feature/award flag determination table (FIG. 8). Subsequently, the CPU 106 references the table 3A, selected from a plurality of the trigger symbol rearrangement pattern/feature game association tables (FIG. 9), and acquires a corresponding rearrangement pattern. Then, a feature game corresponding to the rearrangement pattern is selected. For example, in a case where the display example of FIG. 10 corresponds to a rearrangement pattern “a” in the trigger symbol rearrangement pattern/feature game association table 3A, the feature game to be executed is “abc”.

FIG. 11 shows the symbol display regions 88, 91 and 93 displaying the trigger symbols. As described above, a feature game is selected in accordance with the number and the position of the trigger symbols displayed in the symbol display regions 81 to 95. For example, in the display example of FIG. 11, the number of trigger symbols “7” is 3. Thus, according to the feature/award flag determination table, a trigger symbol rearrangement pattern/feature game association table 3A is referenced. In a case where the positions of the trigger symbols in the display example of FIG. 11 corresponds to a rearrangement pattern “f” in the trigger symbol rearrangement pattern/feature game association table 3A, the feature game to be executed is “opq”.

### Second Embodiment

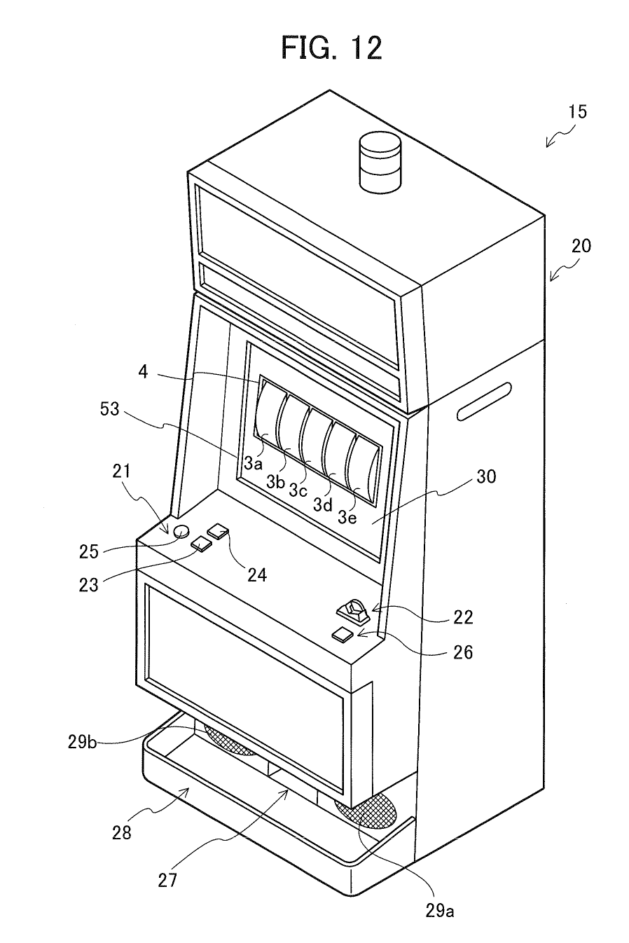

A second embodiment of the present invention is described hereinafter with reference to FIGS. 12 to 14. The second embodiment is different from the first embodiment in that the game includes mechanical reels instead of the 15 video reels constituting the symbol display regions 81 to 95. It should be noted that the differences from the first embodiment are mainly described. Accordingly, descriptions for the same components as those in the first embodiment are omitted. The same components as those in the first embodiment are referenced by the same reference numbers.

FIG. 12 is a perspective view showing the appearance of the gaming machine including mechanical reels. Each of the mechanical reels 3a to 3e has a plurality of symbols along an outer periphery thereof, constituting a symbol group. In addition, the mechanical reels 3a to 3e are visible through a display window 4 provided on a front face of the gaming machine 15, thus showing only a part of the symbols disposed on the outer periphery thereof. In the present embodiment, three symbols are vertically displayed on each of the mechanical reels 3a to 3e. A portion of the display frame 53 disposed on the front face of the gaming machine 15, in which the mechanical reels 3a to 3e are not provided, consists of a liquid crystal display 30 for displaying rendered images, game information and the like. Furthermore, a surface of the liquid crystal display 30 is a touch panel 32, which can accept input operations required for the game.

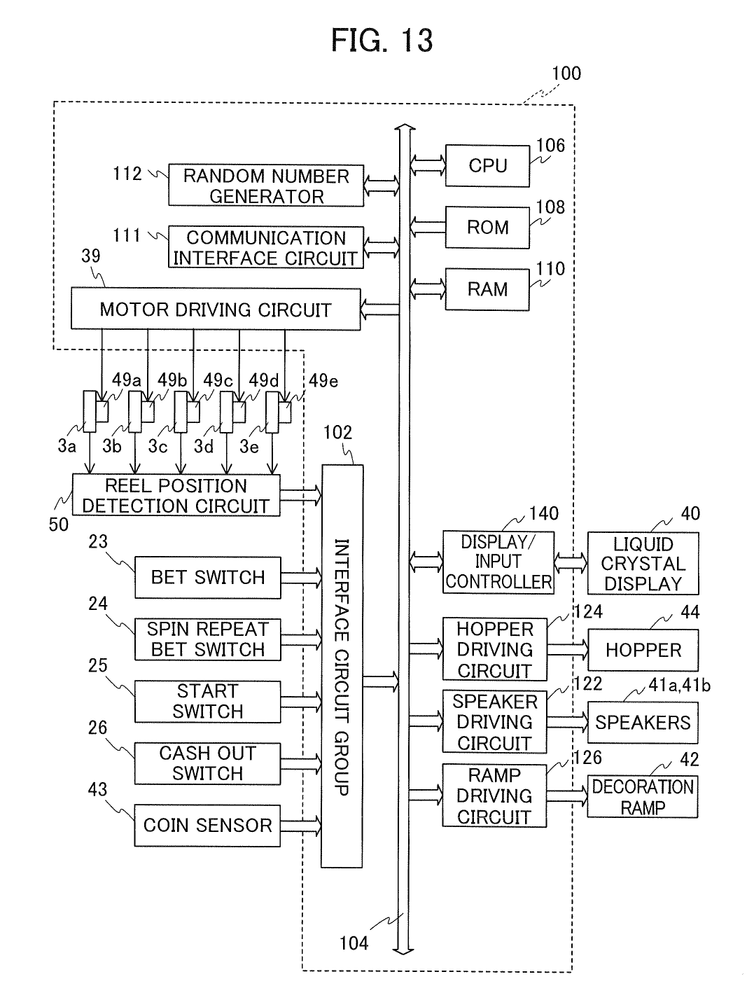

FIG. 13 is a block diagram showing the configuration of the gaming machine 15. Stepping motors 49a to 49e are connected to a motor driving circuit 39 for controlling driving thereof, where the stepping motors, as a main actuator, are controlled by a control signal from the CPU 106 and drive rotation of the mechanical reels 3a to 3e.

In addition, a reel position detection circuit 50 is connected to the mechanical reels 3a to 3e. The reel position detection circuit supplies signals to the CPU 106 for detecting the positions of the mechanical reels 3a to 3e, according to pulse signals received from a reel rotation sensor.

After the mechanical reels 3a to 3e start rotating, the number of the driving pulses, supplied to each of the stepping motors 49a to 49e, is counted. The counted numbers are written to a predetermined area in the RAM 110. A reset pulse is supplied from the mechanical reels 3a to 3e for each complete turn. The driving pulse and the reset pulse are input to the CPU 106 via the reel position detection circuit 50.

Upon reception of the reset pulse, a value of the driving pulse counted in the RAM 123 is initialized to zero. This stores a counted number in the RAM 110 corresponding to the rotational position within one revolution for each of the mechanical reels 3a to 3e.

The ROM 122 stores a symbol table (not shown) for associating the rotational position of each of the reels 3a to 3e with corresponding symbols on the outer peripheries thereof. More specifically, the symbol table provides the relation between the code number and the symbol code, which indicates the symbol provided corresponding to the code number. Here, the code number is provided in increments of a predetermined rotational pitch of each of the mechanical reels 3a to 3e, using the rotational position at which the aforementioned reset pulse is generated as a reference point.

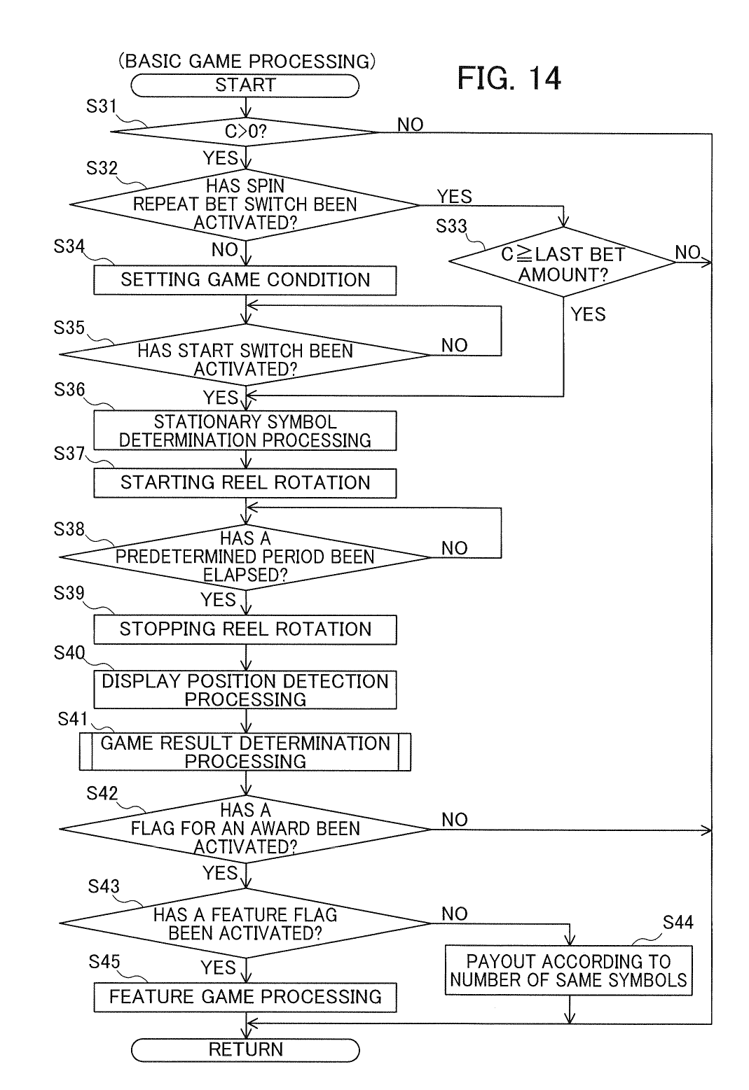

A flow chart of a basic game according to the second embodiment is described with reference to FIG. 14.

In addition, it is supposed that the gaming machine 15 is activated in advance and the variables used in the CPU 106 on the game controller 100 are initialized to predetermined values, respectively, thereby providing a stationary action of the gaming machine 15.

The Steps S31 to S35 are similar to Steps S3 to S5 of the first embodiment, and therefore a description thereof is not repeated.

In Step S36, the CPU 106 determines a stationary symbol. The CPU 106 acquires random numbers in the range of 0 to 65535, generated by a random number generator 112, which correspond to the 5 mechanical reels. The CPU 106 then references symbol weighing data corresponding to the payout ratio setting data, and determines a symbol to be displayed in the center of three symbols displayed on each of the mechanical reels 3a to 3e. The CPU 106 then advances to Step S37.

In Step S37, the CPU 106 starts variably displaying the mechanical reels 3a to 3e. More specifically, the CPU 106 starts rotating the mechanical reels 3a to 3e to variably display the symbols. The CPU 106 waits until a predetermined period of time has elapsed (Step S38). After the predetermined period of time has elapsed (in the case of a YES determination in Step S38), the CPU 106 sequentially stops the mechanical reels 3a to 3e (Step S39). Subsequently, the CPU 106 advances to Step S40.

In Step S40, the CPU 106 performs display position detection processing. In the display position detection processing, the CPU 106 determines whether a winning condition is satisfied or not, on the basis of the stationary symbols determined in Step S36. More specifically, the CPU 106 references the position, indicated by the reel position detection circuit 50, of each of the mechanical reels 3a to 3e, and then determines whether the symbol determined in Step S36 is displayed in the center of three symbols displayed in the display window 4 or not. In a case where the symbol determined in Step S36 is not displayed in the center, the following processing is executed on the basis of the symbols that are actually statically displayed.

In Step S41, the CPU 106 performs game result determination processing. This processing, including subroutines, is similar to Step S7 of FIG. 6 and to the processing shown in FIG. 7 of the first embodiment. After this processing, the CPU 106 advances to Step S42.

In Step S42, the CPU 106 determines whether a flag indicating an award has been activated or not. This and the following processing (Steps S43 to S45) is similar to Steps S11 to S14 in FIG. 6 of the first embodiment, and therefore a description thereof is not repeated. The CPU 106 then terminates the present routine.

While embodiments of the gaming machine according to the present invention have been described, it is to be understood that the above description is intended to be illustrative, and not restrictive, and any changes in design may be made to specific configurations such as various means. It is also to be understood that the effects described in the foregoing embodiments are intended to be illustrative as most preferred effects that the present invention can produce, and the effects according to the present invention are not limited to those described in the foregoing embodiment.

For example, in the present embodiment, the symbols are rearranged while a basic game is in operation, based upon rearrangement pattern data; however, the present invention is not limited thereto, and the symbols can be rearranged while a bonus game is in operation, based upon rearrangement pattern data.

In addition, although video reels are described in the present embodiment, mechanical reels can also be used.

What is claimed is:

1. A gaming machine comprising:
a display for displaying a predetermined symbol in each of a plurality of symbol groups;
memory for storing a plurality of display patterns for a trigger symbol, wherein the trigger symbol is included among the plurality of symbol groups and triggers a transition to a second game by being displayed in any one of the display patterns; and
a controller for executing steps of:
(a) generating random numbers and starting a first game;
(b) determining symbols to be statically displayed on the display in accordance with the random numbers;
(c) dynamically displaying each of the plurality of symbol groups;
(d) displaying each of the symbols determined in step (b) on the display;
(e) determining whether the trigger symbol is displayed in any one of the display patterns or not; and
(f) in a case where the trigger symbol is displayed in any one of the display patterns, executing the second game associated with the display pattern.

2. A gaming machine comprising:
a display for displaying a predetermined symbol in each of a plurality of symbol groups;
memory for storing a plurality of specific positions in the display in which a trigger symbol triggering a transition to a second game is displayed, and a plurality of second games associated therewith; and
a controller for executing steps of:
(a) generating random numbers and starting a first game;
(b) determining a symbol, in each of the plurality of symbol groups, to be statically displayed on the display in accordance with the random numbers;
(c) dynamically displaying each of the plurality of symbol groups;
(d) displaying each of the symbols determined in step (b) on the display;
(e) determining whether the trigger symbol is displayed in the specific position; and
(f) in a case where the trigger symbol is displayed in the specific position, executing the second game corresponding to the specific position.

3. A gaming machine comprising:
a display for displaying a predetermined symbol in each of a plurality of symbol groups;
memory for storing a plurality of combinations of specific positions in the display in which a trigger symbol is displayed and a number of trigger symbols displayed in the display, and a plurality of second games associated with the combinations; and
a controller for executing steps of:
(a) generating random numbers and starting a first game;
(b) determining a symbol, in each of the plurality of symbol groups, to be statically displayed on the display in accordance with the random numbers;
(c) dynamically displaying each of the plurality of symbol groups;
(d) displaying each of the symbols determined in step (b) on the display;
(e) determining whether a predetermined number of the trigger symbols are displayed in a predetermined combination included in the plurality of combinations; and
(f) in a case where the trigger symbols are displayed in the predetermined combination, executing the second game corresponding to the combination.

4. A gaming machine comprising:
a display for displaying a plurality of reels having a plurality of symbols;
memory for storing a plurality of patterns on the display in which a predetermined number of trigger symbols triggering a transition to a second game are displayed, and a plurality of second games associated therewith;
and a controller for executing steps of:
(a) starting a first game;
(b) determining symbols to be rearranged on the display for each of the plurality of reels;
(c) rotating each of the plurality of reels and dynamically displaying the plurality of symbols;
(d) statically displaying the symbols determined in step (b) on each of the plurality of reels;
(e) determining whether a predetermined number of the trigger symbols are included among the symbols statically displayed;
(f) in a case where the result in step (e) is that the predetermined number of the trigger symbols are included, identifying a pattern in which the trigger symbols are displayed; and
(g) in a case where the pattern in which the trigger symbols are displayed corresponds to any one of the plurality of patterns stored in the memory, executing the second game, associated with the pattern, from the plurality of second games.

5. A gaming machine comprising:
a display for displaying a plurality of reels having a plurality of symbols;
memory for storing a position of each of the plurality of reels when a predetermined symbol among the plurality of symbols is displayed on the display, and a plurality of second games associated therewith; and
a controller for executing steps of:
(a) starting a first game;
(b) determining a stopping position of each of the plurality of reels;
(c) rotating the plurality of reels and dynamically displaying the plurality of symbols;
(d) stopping each of the plurality of reels at the stopping position determined in step (b); and
(e) in a case where the stopping positions determined in step (b) correspond to any one of the positions stored in the memory, executing the second game associated with the position.

6. The gaming machine according to claim 5, wherein:
the plurality of symbols are arranged on an outer circumferential surface of each of the plurality of reels;
in step (c), the plurality of symbols are dynamically displayed by the plurality of reels rotating in a direction orthogonal to a predetermined rotation axis thereof; and
the controller further executes steps of:
(d2) identifying the stopping position of the plurality of reels after step (d);
(d3) after step (d2), determining whether the reels are stopped so as to display the predetermined symbol; and
executing step (e) on the basis of the result of the step (d2).
